(19) United States
(12) Patent Application Publication
(10) Pub. No.: US 2009/0040360 A1
(43) Pub. Date: Feb. 12, 2009

(54) IMAGING DEVICE AND PORTABLE TERMINAL DEVICE

(76) Inventor: Koji Taniguchi, Kanagawa (JP)

Correspondence Address: Dickinson Wright PLLC;James E. Ledbetter, Esq., International Square, 1875 Eye Street, N.W., Suite 1200, Washington, DC, 20006, US

(21) Appl. No.: 12/280,346

(22) PCT Filed: Feb. 24, 2006
(86) PCT No.: PCT/JP2006/303462

§ 371 Date: Aug. 21, 2008

(51) Int. Cl. H04N 5/225

(52) U.S. Cl. 348/335; 348/E05.024

(57) ABSTRACT

In a camera module (20) , a flange section (1a) which protrudes to the outer circumference side is arranged on an opening end portion of a lens tube (1). The flange section (1a) is formed to be fitted in a module integrating section (8a) formed on an upper case (8), and the lens tube (1) and a lens (2) are permitted to form a part of an exterior of a portable telephone. Thus, in the conventional constitutions, a certain space or a protection panel is not required to be arranged on an upper portion of a camera module, and a cushioning material is not required to be arranged on a lower portion of the camera module. Thus, a case section of the portable telephone incorporating the camera module is thinned and the portable telephone itself is thinned.

### TECHNICAL FIELD

The present invention relates to an imaging apparatus and a mobile terminal apparatus. More particularly, the present invention relates to an imaging apparatus that incorporates an imaging element and a mobile terminal apparatus such as a mobile telephones that incorporates the imaging apparatus.

### BACKGROUND ART

Conventionally, imaging apparatuses mounted in mobile terminal apparatuses such as mobile telephones include, for example, the solid imaging apparatus and imaging device disclosed in Patent Document 1. FIG. 1 shows a configuration of a camera module as the same conventional imaging apparatus as Patent Document 1. FIG. 1 is a cross sectional view showing a configuration in a state where the camera module is mounted in the mobile telephone.

In FIG. 1, 101 is a lens barrel, 102 is lenses, 103 is a lens fixing ring, 104 is a sealing glass, 105 is an imaging element, 106 is a sensor package, 107 is a substrate, 108 is an upper casing, 109 is a lower casing, 110 is a protection panel and 111 is a cushioning.

Generally, a black resin such as PC (polycarbonate) is formed to manufacture lens barrel 101 to secure the light blocking effect. Lenses 102 are inserted and fit in lens barrel 101. Lenses 102 are configured with two lenses in the figure, using various optical translucent resins and glasses. Lenses 102 are fixed by lens fixing ring 103 so as not to drop from lens barrel 101, which forms a lens assembly. Lens barrel 101 and lens fixing ring 103 are fixed, for example, with screws or by a method such as welding.

Imaging element 105 is positioned precisely and mounted in sensor package 106. For sensor package 106, for example, a ceramic multi-layer substrate with a cavity is used. When this ceramic multi-layer substrate is used as a sensor package, imaging element 105 is positioned precisely in sensor package 106 using an image recognition technique and fixed with adhesive. Then, the terminal (not shown) provided in sensor package 106 is connected with the terminal (not shown) of imaging element 105 by wire bonding. Further, sealing glass 104 is adhered to sensor package 106 by adhesive and sealed to forma sensor package assembly.

Then, the sensor package assembly is mounted in substrate 107. Substrate 107 is, for example, FPC (flexible print circuit) and is mounted by, for example, solder reflowing. Next, the lens assembly is adhered and fixed on the upper part of the sensor package assembly mounted in substrate 107 to form camera module 100.

Camera module 100 formed in this way is incorporated in inner space formed by upper casing 108 and lower casing 109 of a mobile telephone. The outline of lens barrel 101 with respect to upper casing 108 is positioned inside upper casing 108. Further, protection panel 110 formed with, for example, an acrylic resin is attached, as a configuration separate from camera module 100, above lenses 102 of upper casing 108.

Further, to protect camera module 100 from press from outside the casing and shock due to fall, cushioning 111 is arranged on the side of lower casing 109 of camera module 100. A urethane resin, for example, is used for cushioning 111.

Patent Document 1: Japanese Patent Application Laid-Open No. 2003-298891

### DISCLOSURE OF INVENTION

### Problems to be Solved by the Invention

However, according to the configuration of above conventional camera module 100, the thickness of camera module 100 (that is, “h” shown in FIG. 1) claims a significant proportion in the thickness of the mobile telephone, which is a significant obstacle for the increasing demand for thinner mobile telephones in recent years. That is, the certain space and thickness of the protection panel need to be accommodated above the camera module, and so this increases the thickness of a mobile telephone. Further, the space and protection panel provided above the camera module do not contribute to improvement in the essential optical performance of the camera module.

It is therefore an object of the present invention to provide an imaging apparatus and a mobile terminal apparatus that make the space and protection panel provided above the conventional camera module unnecessary, by exposing part of the lens barrel and the frontmost lens and assigning to these a role of an outermost layer, and that makes possible a thinner mobile terminal apparatus.

### Means for Solving the Problem

The imaging apparatus according to the present invention employs a configuration including: a lens; a lens barrel that incorporates the lens; and an imaging element that is arranged on an optical axis of the lens, whereby a flange part is provided in an open end of the lens barrel on a side opposite to a side where the imaging element is provided to hold the imaging apparatus in a casing of a mobile terminal apparatus where the imaging apparatus is incorporated.

Further, the imaging apparatus according to the present invention employs a configuration including: a lens; a lens barrel that incorporates the lens; and an imaging element that is arranged on an optical axis of the lens, whereby: a flange part is provided in the lens on a side opposite to a side where the imaging element is provided to hold the imaging apparatus in a casing of a mobile terminal apparatus where the imaging apparatus is incorporated; and a surface of the lens forms part of an outermost layer of the mobile terminal apparatus.

Further, the mobile terminal apparatus according to the present invention employs a configuration including: a lens; a lens barrel that incorporates the lens; an upper casing that incorporates an imaging apparatus having an imaging element arranged on an optical axis of the lens; and a lower casing, whereby: a flange part is provided in an open end of the lens barrel on a side opposite to a side where the imaging element is arranged, to be held by the upper casing; a surface of the lens barrel that has the flange part forms part of an outermost layer of the mobile terminal apparatus; and a limb that extends toward the lower casing is attached to the upper casing.

### Advantageous Effect of the Invention

The present invention makes the space and protection panel provided above the conventional camera module unnecessary by exposing part of the lens barrel and the frontmost lens and assigning to these a role of an outermost layer, and makes possible a thinner mobile terminal apparatus.

### BRIEF DESCRIPTION OF DRAWINGS

FIG. 1 is a cross sectional view showing a configuration of a conventional camera module;

FIG. 2 is a cross sectional view showing a configuration of a camera module according to Embodiment 1 of the present invention;

FIG. 3 shows (a) a state where the camera module is mounted in a mobile telephone and (b) a state prior to mounting the camera module in the mobile telephone according to Embodiment 1;

FIG. 4 is a cross sectional view showing a configuration of the camera module according to Embodiment 2 of the present invention;

FIG. 5 is a cross sectional view showing the configuration of the camera module according to Embodiment 3 of the present invention; and

FIG. 6 is a cross sectional view showing the configuration of the camera module according to another embodiment of the present invention.

### BEST MODE FOR CARRYING OUT THE INVENTION

Embodiments of the present invention will be described below in detail with reference to the accompanying drawings.

### Embodiment 1

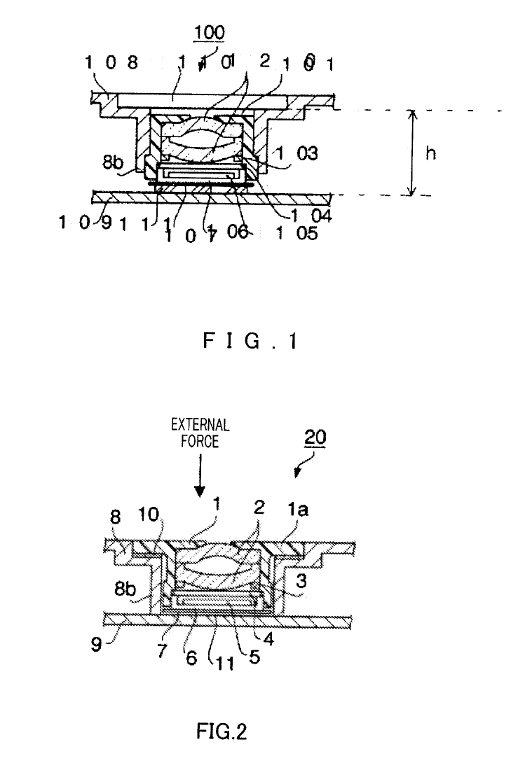

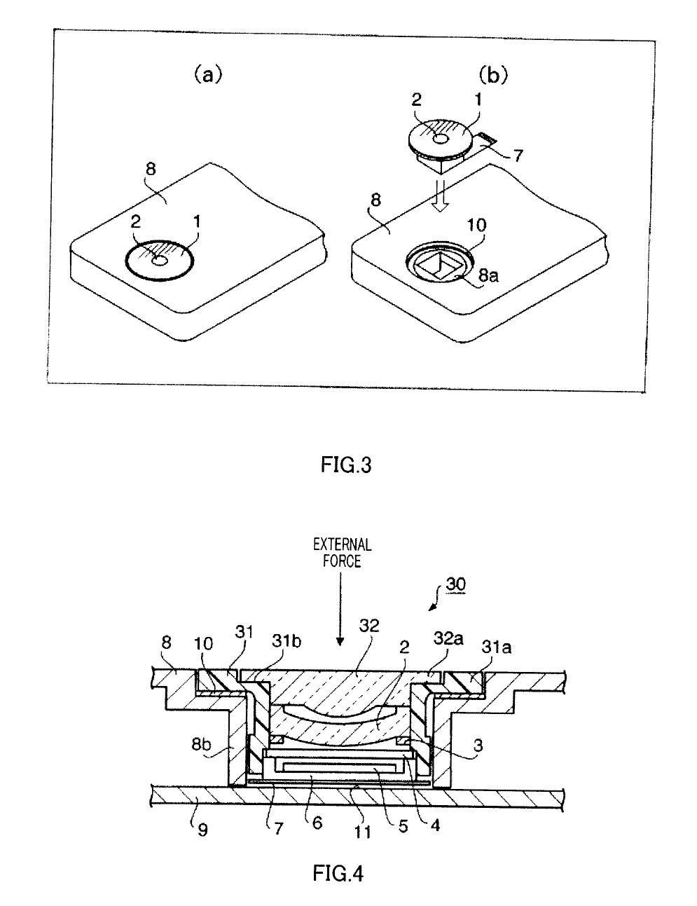

FIG. 2 is a cross sectional view showing a configuration of a camera module which is an imaging apparatus and the structure to be incorporated in a mobile telephone according to Embodiment 1 of the present invention. Further, FIG. 3(a) is a perspective view showing a structure incorporating the camera module in the mobile telephone. FIG. 3(b) is a perspective view showing a structure prior to incorporating the camera module in the mobile telephone.

In FIG. 2, 1 is a lens barrel, 1a is a flange part of lens barrel 1, 2 is lenses, 3 is a lens fixing ring, 4 is a sealing glass, 5 is an imaging element, 6 is a sensor package, 7 is a substrate, 8 is an upper casing and 9 is a lower casing. Further, lens barrel 1, lens 2, lens fixing ring 3, sealing glass 4, imaging element 5, sensor package 6, substrate 7 form cameral module 20. Further, upper casing 8 and lower casing 9 form the outermost layer of the mobile telephone.

Generally, a black resin such as PC (polycarbonate) is formed to manufacture lens barrel 1 to secure the light blocking effect. Lenses 2 are inserted and fit in lens barrel 1. Lenses 2 are configured with two lenses in the figure using various optical translucent resins and glasses. Lenses 2 are fixed by lens fixing ring 3 so as not to drop from lens barrel 1, which forms a lens assembly. Lens barrel 1 and lens fixing ring 3 are fixed, for example, with screws or by a method such as welding.

Imaging element 5 is positioned precisely and mounted on sensor package 6. For sensor package 6, for example, a ceramic multi-layer substrate with a cavity is used. When this ceramic multi-layer substrate is used as a sensor package, imaging element 5 is positioned precisely in sensor package 6 using an image recognition technique and fixed with adhesive. Then, the terminal (not shown) provided in sensor package 6 is connected with the terminal (not shown) of imaging element 5 by wire bonding. Further, sealing glass 4 is adhered to sensor package 6 by adhesive and sealed to form a sensor package assembly.

Then, the sensor package assembly is mounted in substrate 7. Substrate 7 is FPC (flexible print circuit) and is mounted by, for example, solder reflowing. Next, the lens assembly is adhered and fixed on the upper part of the sensor package assembly mounted in substrate 7 to form camera module 20.

With Embodiment 1, as shown in FIG. 2, flange part 1a that extends in the outer peripheral part of the open end is provided in the open end of lens barrel 1 on the side opposite to the side where imaging element 5 is provided. This flange part 1a is formed to fit in module incorporating part 8a formed in upper casing 8 shown in FIG. 3(b).

As shown in FIG. 3(b), camera module 20 is incorporated in upper casing 8 of the mobile telephone in the direction of the arrow. When camera module 20 is incorporated in the mobile telephone, flange part 1a of lens barrel 1 is attached to fit in module incorporating part 8a formed in upper casing 8. Camera module 20 is fixed in upper casing 8 by double-sided tape 10 applied to module incorporating part 8a. FIG. 3(a) shows a state where camera module 20 is incorporated in the mobile telephone as described above.

Further, in FIG. 2, limb 8b that extends toward lower casing 9, is attached to upper casing 8. Thanks to this limb 8b, gap 11 is formed between substrate 7 and lower casing 9 in a state where camera module 20 is attached to camera module incorporating part 8a. This gap 11 is formed by adjusting the size of limb 8b of upper casing 8 according to the thickness of camera module 20. Providing this gap 11 makes the cushioning provided in a conventional camera module unnecessary.

If the above configurations shown in FIG. 2 and FIG. 3 are employed, when external force (the arrow shown in FIG. 2) works from above camera module 20, the casing of the mobile telephone and camera module 20 receive the external force as one, which is completely different from the conventional configuration. That is, when the above external force works upon the mobile telephone, upper casing 8 and camera module 20 are deformed as one, toward lower casing 9. In this case, part of upper casing 8 (limb 8b) hits lower casing 9 before camera module 20 to prevent excessive pressure from working upon camera module 20.

Further, as shown in FIG. 3(a), lens barrel 1 and lenses 2 form part of the outermost layer of the mobile telephone, and so surface processing such as hard coating is applied to the part to be the outermost layer of camera module 20 (including the lens face) to prevent damage. Further, depending on cases, for example, coating may be applied to prevent stains.

As described above, with camera module 20 of Embodiment 1, flange part 1a that extends in the outer periphery of the open end is provided in the open end of lens barrel 1 and this flange part 1a is formed to fit in module incorporating part 8a formed in upper casing 8, so that lens barrel 1 and lenses 2 form part of the outermost layer of the mobile telephone. For this reason, the certain space and protection panel provided above the camera module or a cushioning provided below the camera module, which are required by the conventional configuration, are no longer necessary, so that it is possible to make shorter the overall length (thickness) of the camera module in the height direction. As a result, it is possible to make thinner the casing part of the mobile telephone in which the camera module is incorporated, thereby making possible a thinner mobile telephone.

Further, in upper casing 8 in which camera module 20 of Embodiment 1 is incorporated, limb 8b attached to upper casing 8 is configured to hit lower casing 9 before camera module 20 to prevent excessive pressure from working upon the camera module when external force works, so that the protection panel and cushioning used in the conventional camera module are no longer necessary and the manufacturing cost is reduced.

### Embodiment 2

Features of Embodiment 2 include forming the shape of the upper lens in the camera module to fit in the flange part provided in the lens barrel.

FIG. 4 shows a configuration of the camera module of Embodiment 2. FIG. 4 is a cross sectional view showing the configuration of the camera module which is an imaging apparatus and the structure to be incorporated in the mobile telephone. Further, in FIG. 4, the same components as in the above configuration shown in FIG. 1 will be assigned the same reference numerals.

With Embodiment 2, as shown in FIG. 4, flange part 31a that extends in the outer periphery of the open end is provided in the open end of lens barrel 31 farthest from imaging element 5, and concave part 31b is formed in the inner periphery of flange part 31a. This flange part 31a is formed to fit in module integrating part 8a formed in upper casing 8 shown in FIG. 3(b). On the side of the upper surface, frontmost lens 32 inserted and fit in lens barrel 31 has flange part 32a extending in concave part 31b of lens barrel 31. Further, to provide lens 32 and flange part 32a as one, lens part 32 is formed so as to increase the thickness of flange part 32a and make flat the upper face of lens part 32.

Further, camera module 30 including lens barrel 31 and lens 32 is formed by the same assembling procedure as in above Embodiment 1.

If the configuration shown in FIG. 4 is employed, when external force (the arrow shown in FIG. 4) works from above camera module 30, the casing of the mobile telephone and camera module 30 receive the external force as one, which is completely different from the conventional configuration. That is, when the above external force works upon the mobile telephone, upper casing 8 and camera module 30 are deformed as one, toward lower casing 9. In this event, part of upper casing 8 (limb 8b) hits lower casing 9 before camera module 30 to prevent excessive pressure from working upon camera module 30.

Further, lens barrel 31 and lens 32 form part of the outermost layer of the mobile telephone, and so surface processing such as hard coating is applied to the part to be the outermost layer of camera module 30 (including the lens face) to prevent damage. Further, depending on cases, for example, coating may be applied to prevent stains.

As described above, with Embodiment 2, flange part 31a that extends in the outer periphery of the open end is provided in the open end of lens barrel 31, concave part 31b is provided in the inner periphery of this flange part 31a and frontmost lens 32 that has flange part 32a extending in this concave part 31b is formed to fit in lens barrel 31, so that lens barrel 31 and lens 32 form part of the outermost layer of the mobile telephone. For this reason, the certain space and protection panel provided above the camera module or a cushioning provided below the camera module, which are required by the conventional configuration, are no longer necessary, so that it is possible to make shorter the overall length (thickness) of the camera module in the height direction. As a result, it is possible to make thinner the casing part of the mobile telephone in which the camera module is incorporated, thereby making possible a thinner mobile telephone.

Further, according to cameral module 30 of Embodiment 2, the protection panel and cushioning used in the conventional camera module are no longer necessary and, consequently, the manufacturing cost can be reduced.

### Embodiment 3

Features of Embodiment 3 include forming the shape of the frontmost lens in the camera module to fit in the upper casing of the mobile telephone.

FIG. 5 shows a configuration of the camera module of Embodiment 3. FIG. 5 is a cross sectional view showing the configuration of the camera module which is an imaging apparatus and the structure to be incorporated in the mobile telephone. Further, in FIG. 5, the same components as in the above configuration shown in FIG. 1 will be assigned the same reference numerals.

As shown in FIG. 5, embodiment 3 differs from above Embodiments 1 and 2 in forming the shape of lens barrel 41 virtually a cylinder, without providing a flange part and making shorter the length of lens barrel 41 in the height direction. On the side of the upper surface, frontmost lens 42 inserted and fit in this lens barrel 41 has flange part 42a that extends in concave part 8c (in the outer peripheral) which forms module incorporating part 8a of upper casing 8 (see FIG. 3). Further, to provide lens 42 and flange part 42a as one, lens part 42 is formed so as to increase the thickness of flange part 42a and make flat the upper face of lens part 32.

Further, camera module 40 including lens barrel 41 and lens 42 is formed by the same assembling procedure as in above Embodiment 1.

If the configuration shown in FIG. 5 is employed, when external force (the arrow shown in FIG. 5) works from above camera module 40, the casing of the mobile telephone and camera module 40 receive the external force as one, which is completely different from the conventional configuration. That is, when the above external force works upon the mobile telephone, upper casing 8 and camera module 40 are deformed as one, toward lower casing 9. In this event, part of upper casing 8 (limb 8b) hits lower casing 9 before camera module 40 to prevent excessive pressure from working upon camera module 40.

Further, lens 42 forms part of the outermost layer of the mobile telephone, and so surface processing such as hard coating is applied to the lens face to be the outermost layer of camera module 40 to prevent damage. Further, depending on cases, for example, coating may be applied to prevent stains.

As described above, with Embodiment 3, flange part 42a that extends in concave part 8c of upper casing 8 (in the outer periphery) is provided in frontmost lens 42 that is inserted and fit in lens barrel 41, so that lens 42 forms part of the outermost layer of the mobile telephone. For this reason, the certain space and protection panel provided above the camera module or a cushioning provided below the camera module, which are required by the conventional configuration, are no longer necessary, so that it is possible to make shorter the overall length (thickness) of the camera module in the height direction. As a result, it is possible to make thinner the casing part of the mobile telephone in which the camera module is incorporated, thereby making possible a thinner mobile telephone.

Further, according to cameral module 40 of Embodiment 3, the protection panel and cushioning used in the conventional camera module are no longer necessary and, consequently, the manufacturing cost can be reduced.

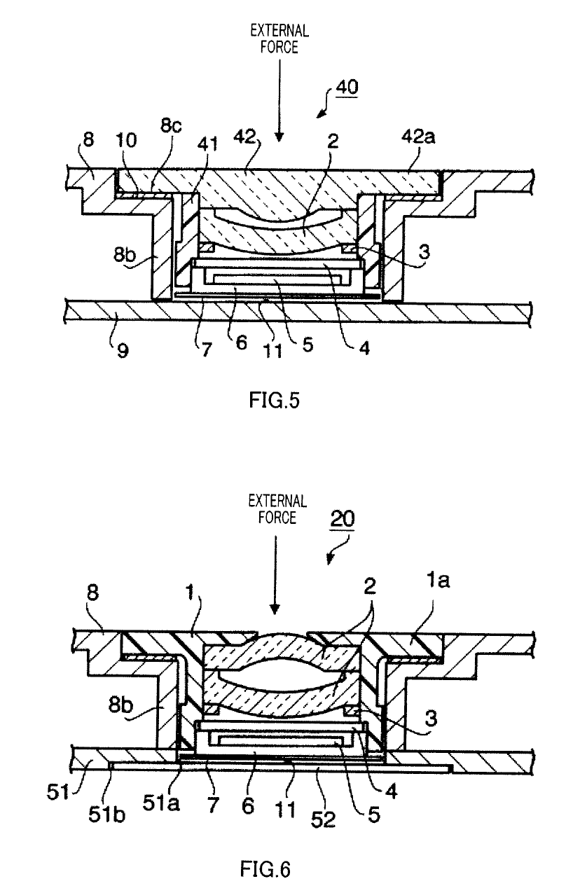

Next, FIG. 6 shows another embodiment. FIG. 6 is a cross sectional view showing the configuration of the camera module which is an imaging apparatus and the structure to be incorporated in the mobile telephone. Further, in FIG. 6, the same components as in the above configuration shown in FIG. 2 will be assigned the same reference numerals. Features of the present embodiment include providing an opening part, into which the camera module is dropped, on the side of the lower casing of the mobile telephone.

As shown in FIG. 6, opening part 51a is formed such that sensor package 6 and substrate 7 of camera module 20 are dropped into lower casing 51, concave part 51b is formed in the outer peripheral part of this opening part 51a and sensor side sealing member 52 made of, for example, a metal plate, is attached to this concave part 51b.

Further, according to the configuration shown in FIG. 6, when external force works, the casing of the mobile telephone and the camera module receive the external force as one and part of upper casing 8 (limb 8b) hits lower casing 52 before camera module 20 to prevent excessive pressure from working upon camera module 20.

When the configuration shown in FIG. 6 is employed, it is possible to further make shorter the overall length of the camera module incorporated in upper casing 8 (thickness) in the height direction, thereby making possible a thinner casing of the mobile telephone in which the camera module is incorporated.

Further, although, with Embodiments 1 and 2, a flange part that is incorporated and fixed is provided in the lens barrel, the present invention is not necessarily limited to such configuration, and it is possible to achieve the same object as long as the lens barrel and upper casing can be fixed and part of the lens barrel forms part of the outermost layer of the mobile telephone. Further, although examples of camera modules that incorporate two pieces of lenses has been shown with above Embodiments 1 to 3, the present invention by no means limits the number of the lenses.

The first aspect of the imaging apparatus according to the present invention employs a configuration including: a lens; a lens barrel that incorporates the lens; and an imaging element that is arranged on an optical axis of the lens, whereby a flange part is provided in an open end of the lens barrel on a side opposite to a side where the imaging element is provided to hold the imaging apparatus in a casing of a mobile terminal apparatus where the imaging apparatus is incorporated.

This configuration makes the space and protection panel provided above the conventional camera module unnecessary and makes possible a thinner imaging apparatus.

The second aspect of the imaging apparatus according to the present invention employs a configuration of providing, in the imaging apparatus according to the first aspect, a flange part in the lens on the side opposite to the side where the imaging element is provided to be held in the flange part of the lens barrel.

This configuration makes the space and protection panel provided above the conventional camera module unnecessary and makes possible a thinner imaging apparatus.

The third aspect of the imaging apparatus according to the present invention employs a configuration where, in the imaging apparatus according to the first or the second aspect, the lens barrel that has the flange part and a surface of the lens form part of an outermost layer of the mobile terminal apparatus.

This configuration makes the space and protection panel provided above the conventional camera module unnecessary by exposing part of the lens barrel and the frontmost lens to the outside of the mobile terminal apparatus and assigning to these a role of the outermost layer, and makes possible a thinner imaging apparatus.

The fourth aspect of the imaging apparatus according to the present invention employs a configuration including: a lens; a lens barrel that incorporates the lens; and an imaging element that is arranged on an optical axis of the lens, whereby: a flange part is provided in the lens on a side opposite to a side where the imaging element is provided to hold the imaging apparatus in a casing of a mobile terminal apparatus where the imaging apparatus is incorporated; and a surface of the lens forms part of an outermost layer of the mobile terminal apparatus.

This configuration makes the space and protection panel provided above the conventional camera module unnecessary by exposing the frontmost lens to the outside of the mobile terminal apparatus and assigning to this a role of the outermost layer, and makes possible a thinner imaging apparatus.

The fifth aspect of the mobile terminal apparatus according to the present invention employs a configuration including: a lens; a lens barrel that incorporates the lens; an upper casing that incorporates an imaging apparatus having an imaging element arranged on an optical axis of the lens; and a lower casing, whereby: a flange part is provided in an open end of the lens barrel on a side opposite to a side where the imaging element is arranged, to be held by the upper casing; a surface of the lens barrel that has the flange part forms part of an outermost layer of the mobile terminal apparatus; and a limb that extends toward the lower casing is attached to the upper casing.

This configuration makes the space and protection panel provided above the conventional camera module unnecessary by exposing part of the lens barrel and the frontmost lens to the outside of the mobile terminal apparatus and assigning to these a role of the outermost layer, and makes possible a thinner imaging apparatus. Further, a limb attached to the upper casing is configured to hit the lower casing before the camera module to prevent excessive pressure from working upon the camera module when external force works, so that the protection panel and cushioning used in the conventional camera module are no longer necessary and the manufacturing cost is reduced.

### INDUSTRIAL APPLICABILITY

The present invention is useful in making the space and protection panel provided above the conventional camera module unnecessary by exposing part of the lens barrel and the frontmost lens to the outside of the mobile terminal apparatus and assigning to these a role of the outermost layer and in making possible a thinner imaging apparatus.

1. An imaging apparatus comprising:
a lens;
a lens barrel that incorporates the lens; and
an imaging element that is arranged on an optical axis of the lens,
wherein a flange part is provided in an open end of the lens barrel on a side opposite to a side where the imaging element is provided to hold the imaging apparatus in a casing of a mobile terminal apparatus where the imaging apparatus is incorporated.

2. The imaging apparatus according to claim 1, wherein a flange part is provided in the lens on the side opposite to the side where the imaging element is provided to be held in the flange part of the lens barrel.

3. The imaging apparatus according to claim 1, wherein the lens barrel that has the flange part and a surface of the lens form part of an outermost layer of the mobile terminal apparatus.

4. An imaging apparatus comprising:
a lens;
a lens barrel that incorporates the lens; and
an imaging element that is arranged on an optical axis of the lens, wherein:
a flange part is provided in the lens on a side opposite to a side where the imaging element is provided to hold the imaging apparatus in a casing of a mobile terminal apparatus where the imaging apparatus is incorporated; and
a surface of the lens forms part of an outermost layer of the mobile terminal apparatus.

5. A mobile terminal apparatus comprising:
a lens;
a lens barrel that incorporates the lens;
an upper casing that incorporates an imaging apparatus having an imaging element arranged on an optical axis of the lens; and
a lower casing, wherein:
a flange part is provided in an open end of the lens barrel on a side opposite to a side where the imaging element is arranged, to be held by the upper casing;
a surface of the lens barrel that has the flange part forms part of an outermost layer of the mobile terminal apparatus; and
a limb that extends toward the lower casing is attached to the upper casing.
